(19) United States
(12) Patent Application Publication
(10) Pub. No.: US 2026/0061792 A1
(43) Pub. Date: Mar. 5, 2026

(54) Suspension link for vehicles, in particular motor vehicles, and method for manufacturing such a suspension link

(71) Applicant: Willi Elbe Gelenkwellen GmbH & Co. KG, Tamm (DE)

(72) Inventors: Jörg HAUHOFF, Altdorf (DE); Ralf SEDLMEIER, Pleidelsheim (DE); Thomas GERLACH, Weinsberg (DE)

(73) Assignee: Willi Elbe Gelenkwellen GmbH & Co. KG, Tamm (DE)

(21) Appl. No.: 19/309,541

(22) Filed: Aug. 25, 2025

(30) Foreign Application Priority Data
Aug. 27, 2024 (DE) 10 2024 002 826.9

(51) Int. Cl. B60G 7/00

(52) U.S. Cl. CPC B60G 7/001; B60G 2204/422; B60G 2206/122; B60G 2206/7102; B60G 2206/8103; B60G 2206/8105

(57) ABSTRACT

A suspension link for motor vehicles includes an elongated base body with a connection at each of two ends. The base body is formed as a one-piece hollow profile by extrusion and subsequently bent into a curved shape. The cross-section may be rectangular and constant along at least part of the length, and the link may consist of aluminum or an aluminum alloy. A method of manufacturing the suspension link includes producing a blank by extrusion with the base body and connections in raw form, and bending the blank into a curved shape. The method may further include forming at least one connection during or after extrusion, machining the connections after bending, and subjecting the blank to heat treatment. The extrusion may be carried out as cold or forward extrusion.

### CROSS-REFERENCE TO RELATED APPLICATION

This application claims the benefit of German Patent Application DE 10 2024 002 826.9, filed on Aug. 27, 2024, the content of which is incorporated by reference in its entirety.

### TECHNICAL FIELD

The disclosure relates to a suspension link for vehicles, in particular motor vehicles.

### BACKGROUND

Suspension links in automotive engineering are manufactured either as drop-forged parts from solid material or from sheet steel in a welded construction. If the suspension link is formed by a drop-forged part, it has a relatively high weight, which is particularly noticeable when the vehicle has several such suspension links.

If the suspension link is formed as a welded construction from sheet steel, it weighs less than the drop-forged part, but the manufacture of such a welded construction is complex.

### SUMMARY

An object of the disclosure is to develop the generic suspension link and the method in such a way that the suspension link can be manufactured simply and cost-effectively such that it only weighs very little, but has high load-bearing capacity.

This object is solved by a suspension link and a method as disclosed and claimed.

In the suspension link, at least the base body is formed as a one-piece hollow profile part, which is manufactured by an extrusion and subsequent bending process. Due to the hollow profile design, the suspension link has a low weight. The extrusion process makes it very east to manufacture the hollow profile design. The subsequent bending process ensures that the blank produced after the extrusion process is bent into the shape required for the suspension link. Due to the hollow profile design, the suspension link has a low weight, simple and cost-effective manufacture, and high load-bearing capacity.

Advantageously, the base body has a rectangular cross-section. This ensures high strength while having a lightweight design.

The base body being curved transversely to its longitudinal direction contributes to this.

Cost-effective and simple manufacturing is achieved when the base body has a constant cross-section over at least part of its length.

The suspension link is preferably made of aluminum or an aluminum alloy. This material enables the suspension link to be designed to be lightweight while also offering high strength and load-bearing capacity.

In the method for manufacturing a suspension line, the blank is first produced by extrusion, wherein the blank has the base body and the connections in a raw form. This blank is then subjected to a bending process, which brings it into a curved shape.

This method allows the suspension link to be manufactured easily and cost-effectively.

It is advantageous to form a connection onto the blank after extrusion. This can be achieved, for example, with the aid of a die.

The other connection of the suspension link is preferably created during the extrusion process. The corresponding punch is designed in such a way that this connection is created during extrusion, such that no additional operation is required to create this connection.

It is advantageous to machine the two connections after bending.

It is advantageous for the process if the blank is subjected to heat treatment after extrusion. This allows any stresses in the blank to be relieved, for example, such that the subsequent bending process can be carried out without any problems.

The usual extrusion methods can be used for the extrusion process. Cold extrusion is particularly advantageous.

A preferred embodiment consists in producing the blank in a forward extrusion process.

The subject matter of the application is not only derived from the subject matter of the individual claims, but also from all information and features disclosed in the drawings and the description. Even if they are not the subject matter of the claims, they are claimed as essential to the invention insofar as they are novel, individually or in combination, compared to the prior art. Further features of the invention emerge from the further claims, the description and the drawings.

### BRIEF DESCRIPTION OF THE DRAWINGS

The invention is explained in more detail using two embodiments depicted in the drawings.

FIG. 1 shows a perspective depiction and a longitudinal section of a suspension link,

FIG. 2 the suspension link according to FIG. 1 in perspective depiction,

FIG. 3 to FIG. 5 different stages in the manufacture of the suspension link,

FIG. 6 a perspective depiction of a slug for manufacturing the suspension link,

FIG. 7 a view and partial cross-section of an extrusion tool for manufacturing the suspension link in an initial position,

FIG. 8 the extrusion tool according to FIG. 7 after the extrusion process,

FIG. 9 a side view of the blank of the suspension link after the extrusion

process,

FIG. 10 a die for manufacturing a connection of the suspension link in an initial position,

FIG. 11 the die according to FIG. 10 after the machining process,

FIG. 12 a side view of the blank of the suspension link after plastic deformation in the die,

FIG. 13 a schematic depiction and cross-section of a bending tool in the initial position,

FIG. 14 the bending tool according to FIG. 13 after the bending process.

### DETAILED DESCRIPTION

The suspension link is used in motor vehicles and has a base body 1 that is curved transversely to its longitudinal direction over its length and has a connection 2 and 3 at each end for fixation in the vehicle.

The connection 2 is formed by two parallel legs 2a, 2b, which are advantageously of identical design. The two legs 2a, 2b are each connected to the base body 1, which advantageously has a rectangular cross-section, via a cross piece 5.

The legs 2a, 2b of the connection 2 are offset laterally relative to the base body 1. The legs 2a, 2b are provided with a through-opening 4 near their free end for a fastening means, such as screws, bolts and the like.

The legs 2a, 2b are straight along their length and advantageously have a constant thickness and width along their length.

The connection 3 located at the other end of the base body 1 is designed as a bearing eye, with which the suspension link can be attached to the chassis of a motor vehicle in a known manner. The connection 3 is advantageously designed such that the outer diameter 6 of the connection 3 is greater than the height 7 of the base body 1. It has this height 7 over almost its entire length. Depending on the installation conditions and requirements for the suspension link, the base body 1 can also have different heights over its length.

The base body 1 has a central part 8 which is designed as a hollow body. It has side walls 8a, 8b which are connected to each other by cross walls 9, 10. The cross walls 9, 10 advantageously run parallel to each other. The side walls 8a, 8b are also advantageously parallel to each other. The side walls 8a, 8b and the transverse walls 9, 10 form the outer sides of the central part 8.

As can be seen from FIGS. 1 and 2, the central part 8 has an angular, advantageously rectangular cross-section.

The suspension link is designed as a single piece and can be manufactured substantially by means of an extrusion and bending process, as will be described below.

The connection 3 preferably has the same width as the cross walls 9, 10.

The base body 1 is designed as a hollow profile part and is made of aluminum or an aluminum alloy. This means that the suspension link has a low weight. Compared to conventional suspension links, which are manufactured as drop-forged parts, this results in a significant weight reduction of more than 10%. The suspension link offers a load-bearing capacity and strength comparable to that of known suspension links.

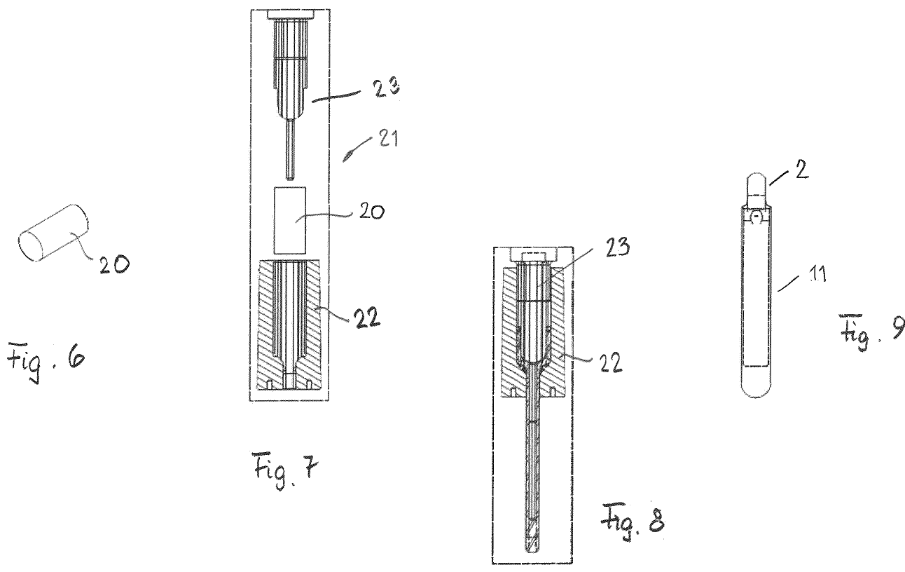

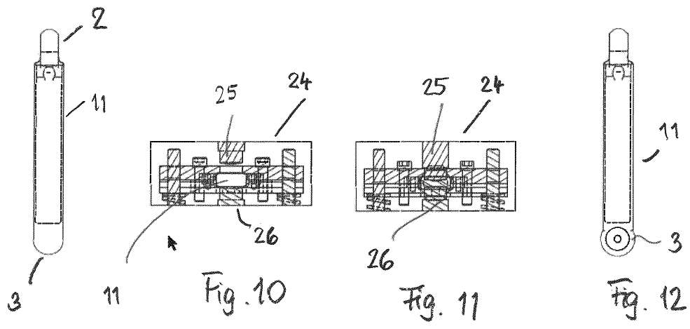

During manufacture, in a first step, a blank 11 of the suspension link is produced by extrusion (FIGS. 6 to 9). Extrusion is a cold forming process used to produce hollow profile parts made of aluminum or an aluminum alloy. They have a low wall thickness but high strength.

The blank 11 is produced by a hollow extrusion process, wherein the blank 11 can be produced by both forward extrusion and reverse extrusion. The blank is produced with a predominantly thin wall.

Cold extrusion produces a surface with good roughness values and very high dimensional and shape accuracy.

An aluminium-magnesium-silicon alloy, which is a high-strength alloy for highly stressed structural applications, is advantageously used as the material for the suspension link. By way of example, an ENAW6082 alloy is used.

FIG. 3 shows this blank 11 after the extrusion process. It already has the base body 1 and the connections 2, 3, which, however, are not yet formed as connections but are still unmachined as raw forms.

The initially straight suspension link is subjected to heat treatment to relieve any stresses in the blank 11 such that the blank 11 can be brought into the desired curved shape by means of a bending process in a subsequent process step (FIG. 4).

The bending tool used for the bending process (FIG. 4) is designed such that the blank 11 formed after extrusion can be bent into the desired shape. Since the suspension link is formed from a hollow profile part, the bending process can be carried out easily and reliably.

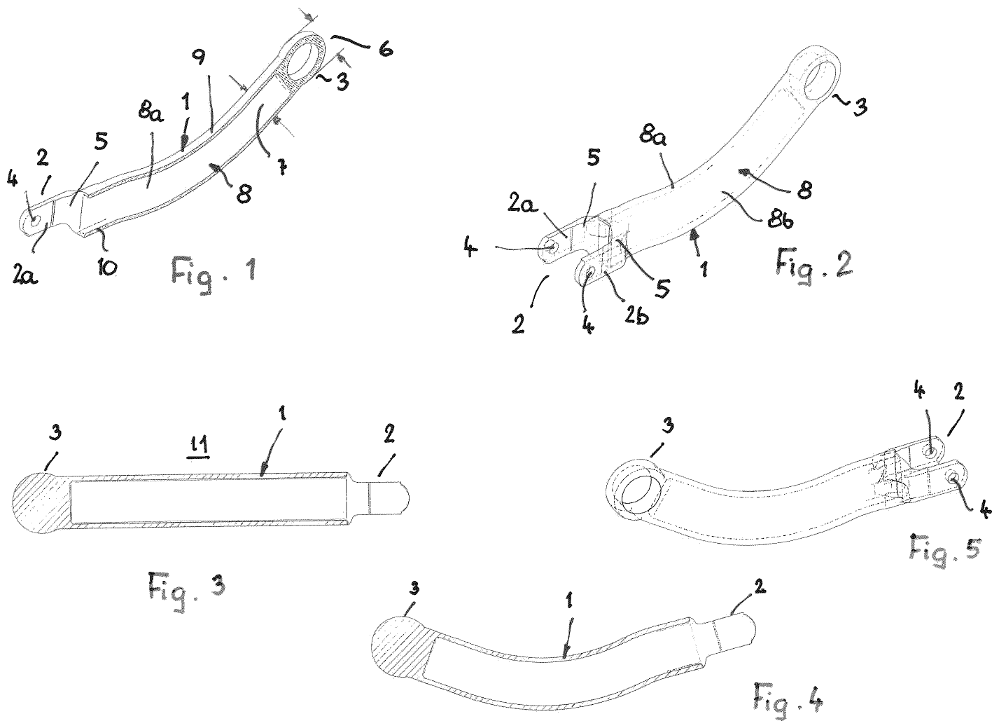

As a final step (FIG. 5), the blank 11 is machined to produce the connections 2 and 3. The machining of the suspension link takes place after the bending process. This allows the through-openings 4 to be produced at the connection 3 and the corresponding bearing eye at the connection 3 with a high degree of accuracy.

During the manufacture of the suspension link by extrusion, bending and machining, heat treatments can be applied to favorably influence the extrusion process or the bending process.

FIGS. 6 to 14 illustrate how the suspension link is manufactured using an exemplary embodiment. This procedure is only to be understood as an example and does not represent a restriction to this procedure.

A slug 20, which is formed as a solid cylinder (FIG. 6), is used as the starting material for the suspension link. The slug 20 is plastically deformed in a known manner in an extrusion tool 21. It has a matrix 22 and a punch 23, which plunges into the die 22 during the extrusion process and deforms the slug 20 in such a way that that the blank 11 is produced.

The punch 23 is designed such that the blank 11 has the connection 2 with the two legs 2a, 2b (FIG. 2) after the extrusion process. To produce the suspension link according to FIG. 1, the punch 23 has a corresponding shape.

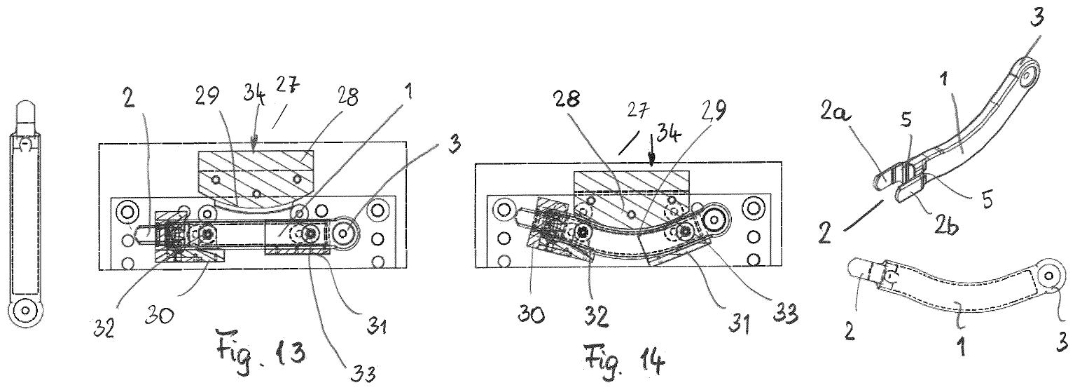

The blank 11 is then placed in a die 24 (FIGS. 10 and 11), which has an upper die 25 and a lower die 26. The die 24 is used to form the connection 3 on the blank 11 in the usual manner. For the forming process, one end of the blank 11 is placed on the lower die 26 and subsequently the upper die 25 is moved downwards.

After this forming process, the suspension link is provided with the connection 2 and the connection 3, wherein the connection 2 is provided with the two legs 2a, 2b that were created during the extrusion process.

In order to give the suspension link its described curved shape, it is bent along its length using a bending tool 27 (FIGS. 13 and 14). The bending tool 27 has a bending punch 28 which has a bending surface 29 corresponding to the desired bend.

The bending punch 28 is adjustable in height relative to two supports 30, 31. The two supports 30, 31 are pivotably mounted about two parallel pivot axes 32, 33. The pivot axes 32, 33 are perpendicular to the adjustment direction 34 of the bending punch 28.

The two supports 30, 31 are spaced apart and arranged such that the suspension link in its straight form with the two connections 2, 3 projects over the ends of the supports 30, 31 facing away from each other (FIG. 13). The bending punch 28 is then moved downwards in the direction 34, causing the suspension link to be bent into the desired shape along its length. During this bending process, the supports 30, 31 pivot about the pivot axes 32, 33, such that the suspension link can be reliably brought into the bent shape. The radius of curvature of the base body 1 of the suspension link is produced by the curved bending surface 29 of the bending punch 28.

The supports 30, 31 are designed such that they overlap the ends of the suspension link, such that they can be reliably bent with the bending punch 28.

The bending punch 28 and the supports 30, 31 are interchangeable in the bending tool 27, such that these parts can be exchanged depending on the desired bending radius of the suspension link.

If necessary, machining operations can then be carried out on the connections 2, 3 of the suspension link.

1. A suspension link for motor vehicles, comprising:
an elongated base body (1) having a connection (2, 3) on each of two ends,
wherein the elongated base body (1) is formed as a one-piece hollow profile part produced by an extrusion process and a subsequent bending process.

2. The suspension link according to claim 1,
wherein the elongated base body (1) has a rectangular cross-section.

3. The suspension link according to claim 1,
wherein the elongated base body (1) is curved transversely to its longitudinal direction.

4. The suspension link according to claim 1,
wherein the elongated base body (1) has a constant cross-section at least across a part of its length.

5. The suspension link according to claim 1,
wherein the suspension link consists of aluminum or an aluminum alloy.

6. A method for manufacturing a suspension link having an elongated base body (1) and having a connection (2, 3) at each of two ends, the method comprising:
producing a blank (11) by extrusion, the blank having the elongated base body (1) and the connections (2, 3) in raw form; and
bending the blank (11) into a curved shape.

7. The method according to claim 6,
forming the connection (3) on the blank (11) after the extrusion.

8. The method according to claim 6,
wherein the connection (2) at one of the two ends is produced during extrusion.

9. The method according to claim 6, further comprising
machining the connection (2, 3) at each of the two ends after bending.

10. The method according to claim 6, further comprising
subjecting the blank (11) to heat treatment after the extrusion.

11. The method according to claim 6,
wherein the extrusion is a cold extrusion.

12. The method according to claim 6,
wherein the blank (11) is produced by forward extrusion.
